(19) United States
(12) Patent Application Publication
(10) Pub. No.: US 2011/0075730 A1
(43) Pub. Date: Mar. 31, 2011

(54) Row Evaluation Rate Control

(75) Inventors: Jonatan Samuelsson, Skarpnack (SE); Per Fröjdh, Stockholm (SE); Clinton Priddle, Upplands Vasby (SE); Rickard Sjöberg, Stockholm (SE)

(73) Assignee: TELEFONAKTIEBOLAGET L M ERICSSON (PUBL), Stockholm (SE)

(21) Appl. No.: 12/992,043

(22) PCT Filed: Jun. 25, 2008
(86) PCT No.: PCT/SE08/50766

§ 371 Date: Nov. 10, 2010

(51) Int. Cl. H04N 7/26; H04N 7/30

(52) U.S. Cl. 375/240.03; 375/E07.232; 375/E07.139

(57) ABSTRACT

A communication device and method for controlling a bit rate when encoding video data that includes a plurality of frames. The method includes partitioning a received current frame into groups of blocks; estimating an energy for a current group of blocks, where the energy of the current group of blocks depends from a same group of blocks in a previous frame; determining a target number of bits for the current group of blocks; calculating a quantization parameter for the current group of blocks of the current frame based on the estimated energy of the current group of blocks and the determined target number of bits for the current group of blocks; and encoding the current group of blocks based on the calculated quantization parameter.

### TECHNICAL FIELD

The present invention generally relates to encoding video data, and more specifically, to a method and device for controlling a bit rate when encoding the video data.

### BACKGROUND

The demand for exchanging video data between mobile communication devices is becoming more popular as the speed and the quality of the transmitted video increases. For transmitting video data in a wireless environment, which is known to be limited by the available bandwidth and plagued by quality problems, manipulation and/or storage of large amount of information consumes both time and resources. For increasing the quality of the transmitted video data, a greater amount of information is required, as this increased amount of information provides for better visual quality. Thus, compression techniques were developed to compress the transmitted video to sizes that can achieve a balance between maintaining the visual quality and reducing the amount of information necessary for displaying the video.

In order to reduce the amount of information necessary to display video, the compression techniques take advantage of the human visual system. Information that cannot be perceived by the human eye is typically removed. In addition, information is often repeated across multiple frames in a video sequence. To reduce the amount of information, redundant information is also removed from a video sequence. A video compression technique is described in detail in the Moving Pictures and Experts Group-2 (MPEG-2) standard in ISO/IEC 13518-2, “Information technology-generic coding of moving pictures and associated audio information: Video, 1996,” which is incorporated herein by reference.

The encoders are developed to perform in a constant bit rate (CBR) mode, where the average rate of the video stream is mainly the same from start to finish. A video stream includes a plurality of pictures or frames of various types, such as I, B and P picture types as defined by the MPEG-2 standard. A picture, depending on its type, may consume more or less bits than the set target rate of the video stream. The CBR rate-control strategy maintains a bit ratio between the different picture types of the stream, such that the desired average bit rate is satisfied, and a high quality video sequence is displayed. Other encoders, for example MPEG-2, perform in a variable bit rate (VBR) mode. Variable bit rate encoding allows each compressed picture to have a different amount of bits based on the complexity of intra and inter-picture characteristics. For example, the encoding of scenes with simple picture content consumes fewer bits than scenes with complicated picture content, in order to achieve the same perceived picture quality.

VBR encoding is accomplished in non-real time using two or more passes because of the amount of information that is needed to characterize the video and the complexity of the algorithms needed to interpret the information to effectively enhance the encoding process. In a first pass, encoding is performed and statistics are gathered and analyzed. In a second pass, the results of the analysis are used to control the encoding process. Although the VBR process produces a high quality compressed video stream, it does not allow for real-time operation.

The discussed compression techniques are generally based on a rate control algorithm that dynamically adjusts the parameters of the encoder to achieve the desired target bit rate. The rate control algorithm allocates a budget of bits to each group of pictures, individual picture and/or sub-picture in a video sequence. Block-based hybrid video encoding schemes such as the MPEG and H.26* (standard for video compressing developed by ITU Telecommunication Standardization Sector) families are inherently losing information. These processes achieve compression not only by removing truly redundant information from the bit stream, but also by making small quality compromises in ways that are intended to be minimally perceptible. In particular, a quantization parameter (QP) regulates how much spatial detail is saved. When QP is small, almost all that detail is retained. As QP is increased, some of that detail is aggregated so that the bit rate drops, but at the price of some increase in distortion and some loss of quality. In this regard, FIG. 1 shows the relationship between the bit rate and the QP for a particular input picture. According to FIG. 1, if a lower bit rate is desired, then the QP has to be lowered at a cost of increased distortion. FIG. 2 shows that as the source complexity varies during a sequence (complexity increases in the direction of the arrow), the distortion increases and the quality decreases, i.e., move from one such curve to another.

FIG. 3 illustrates the open loop (or VBR) operation of a video encoder 10. The user supplies two inputs, the uncompressed video source 12 and a value for QP 14. As the source sequence progresses, the encoder 10 generates compressed video 16 of fairly constant quality, but the bit rate 18 may vary drastically. Because the complexity of pictures is continuously changing in a real video sequence, it is not clear what value of QP to provide to the encoder. If the QP is fixed to a predetermined value for an “easy” part of the sequence having slow motion and uniform areas, then the bit rate may increase drastically when the “hard” (i.e., more complex) parts of the video are reached. However, constraints imposed by the decoder buffer size and network bandwidth force the encoder to encode the video at a nearly constant bit rate. To achieve this constant bit rate, the QP may be dynamically varied by a rate controller 20 as shown in FIG. 4. FIG. 4 shows that the complexity of the uncompressed source 12 is estimated and a signal 22 indicative of that complexity is supplied to the rate controller 20, upon which each picture (or group of pictures) receives an appropriate allocation of bits to work with. Rather than specifying QP as an input, the user specifies a demanded bit rate 24 instead.

Thus, a bit rate control unit may be a part in a video encoder. Often, when video data is to be encoded, there is a need for a specific size or rate of the encoded video in bits per second. In all modern video codecs, the bit rate (and the quality) of the encoded video depends on the level at which the transformation coefficients are quantized (QP). However, for different video sequences, different QP yields different bit rates. Thus, the QP may be changed as the coding advances in order to produce a certain bit rate.

Two different rate controls are described in Sullivan et al., JVT-1049, Joint Model Reference Encoding Methods and Decoding Concealment Methods, ftp3.itu.ch/av-arch/jvt-site/2003_{—}09_SanDiego/JVT-1049d0.doc and Beom J, U.S. Patent Application Publication 20050036698, the content of which is incorporated by reference herein. Sullivan et al. describes a rate control that uses a Mean of Absolute Difference (MAD) from a previous picture to calculate the QP for a basic unit (an arbitrary number of macroblocks). Beom does not use information from a previous frame but divides the picture into rows of macroblocks and then a number of bits is allocated to a current picture on the basis of previous encoding results without defining a relation between an encoding rate and a distortion. The limited number of bits is not forced when features of the current picture are different from those of the previous pictures, and a quantizer scale is set adaptively to various features of the current picture without using an additional number of bits corresponding to variation of the quantizer scale.

However, the rate control mechanisms discussed above do not provide a method for rate control that focuses on conversational applications where there is a demand for fast encoding and constant bit rate. These mechanisms are faced with a question of performance contra speed. Accordingly, it would be desirable to provide devices, systems and methods for controlling a bit rate that avoid the afore-described problems and drawbacks.

### SUMMARY

According to an exemplary embodiment, there is a method for controlling a bit rate when encoding video data that includes a plurality of frames. The method include partitioning a received current frame into groups of blocks; estimating a current row energy for a current group of blocks, wherein the current row energy of the current group of blocks is based, at least in part, on a corresponding row energy associated with a corresponding group of blocks in a previous frame; determining a target number of bits for the current group of blocks; calculating a quantization parameter for the current group of blocks of the current frame based on the estimated current row energy of the current group of blocks and the determined target number of bits for the current group of blocks; and encoding the current group of blocks based on the calculated quantization parameter.

According to another embodiment, there is a computer readable medium for storing computer executable instructions, wherein the instructions, when executed by a processor, cause the processor to control a bit rate when encoding video data that includes a plurality of frames. The instructions include partitioning a received current frame into groups of blocks; estimating a current row energy for a current group of blocks, wherein the current row energy of the current group of blocks is based, at least in part, on a corresponding row energy associated with a corresponding group of blocks in a previous frame; determining a target number of bits for the current group of blocks; calculating a quantization parameter for the current group of blocks of the current frame based on the estimated current row energy of the current group of blocks and the determined target number of bits for the current group of blocks; and encoding the current group of blocks based on the quantization parameter.

According to still another embodiment, there is a communication device for controlling a bit rate when encoding video data that includes a plurality of frames. The device includes a processor configured to partition a current frame into groups of blocks; to estimate a current row energy for a current group of blocks, wherein the current row energy of the current group of blocks is based, at least in part, on a corresponding row energy associated with a corresponding group of blocks in a previous frame; to determine a target number of bits for the current group of blocks; and to calculate a quantization parameter for the current group of blocks of the current frame based on the estimated current row energy of the current group of blocks and the determined target number of bits for the current group of blocks; and an encoding unit connected to the processor and configured to encode the current group of blocks based on the calculated quantization parameter.

According to another exemplary embodiment, there is a communication device for controlling a bit rate when encoding video data that includes a plurality of frames. The device includes means for partitioning a received current frame into groups of blocks; for estimating a current row energy for a current group of blocks, wherein the current row energy of the current group of blocks is based, at least in part, on a corresponding row energy associated with a corresponding group of blocks in a previous frame; for determining a target number of bits for the current group of blocks; and for calculating a quantization parameter for the current group of blocks of the current frame based on the estimated current row energy of the current group of blocks and the input target number of bits for the current group of blocks; and means for encoding the current group of blocks based on the calculated quantization parameter.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 shows a relationship between a bit rate and QP for a particular input picture;

FIG. 2 shows the increased complexity resulting in increased distortion and decreased quality;

FIG. 3 shows an encoder for encoding an uncompressed source;

FIG. 4 shows the encoder controlled by a rate controller;

FIG. 5 illustrates a structure of a communication device capable of encoding video according to an exemplary embodiment;

FIG. 6 is a graph showing QP and energy values calculated after encoding for an exemplary frame;

FIG. 7 shows a pixel in the current frame compared to a corresponding pixel in the (latest encoded) reconstructed frame;

FIG. 8 illustrates the extracted sum of absolute differences method;

FIG. 9 shows that previous group of blocks 1 and group of blocks 2 are used when calculating QP for a current group of blocks 3;

FIG. 10 is a flow diagram illustrating a process for encoding a frame according to an exemplary embodiment;

FIG. 11 is a flow diagram illustrating more details of encoding the frame of FIG. 10;

FIG. 12 is a flow diagram illustrating optional steps to the encoding process of FIG. 10;

FIG. 13 is a flow diagram illustrating further optional steps to the encoding process of FIG. 10; and

FIG. 14 is a flow diagram illustrating steps for implementing the process shown in FIG. 10.

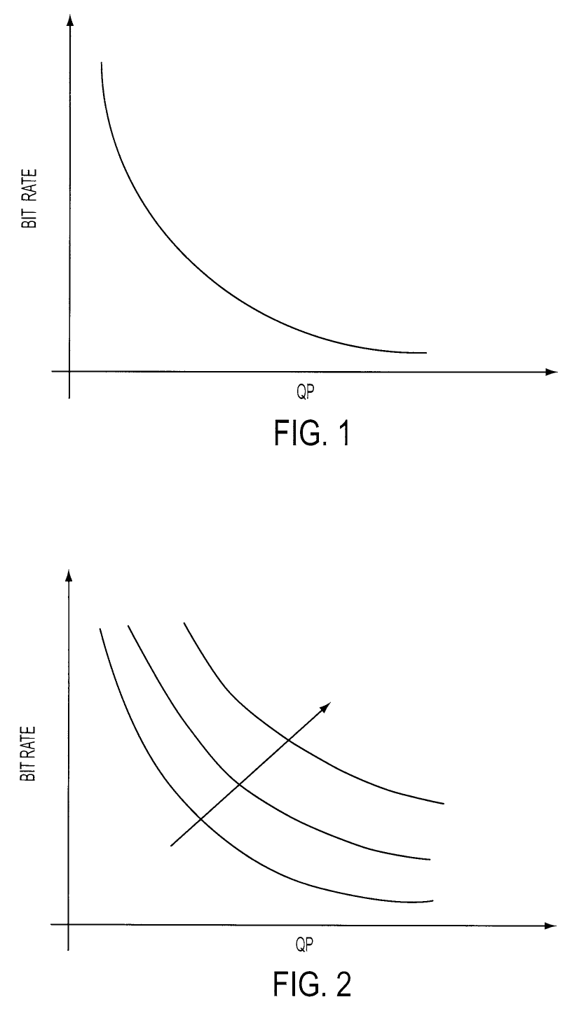

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the video codec H.264 terminology. However, the embodiments discussed next are not limited to this codec but may be applied to other existing systems.

Reference throughout the specification to “one embodiment” or “an embodiment” means that a particular feature, structure, or characteristic described in connection with an embodiment is included in at least one embodiment of the present invention. Thus, the appearances of the phrases “in one embodiment” or “in an embodiment” in various places throughout the specification are not necessarily all referring to the same embodiment. Further, the particular features, structures or characteristics may be combined in any suitable manner in one or more embodiments.

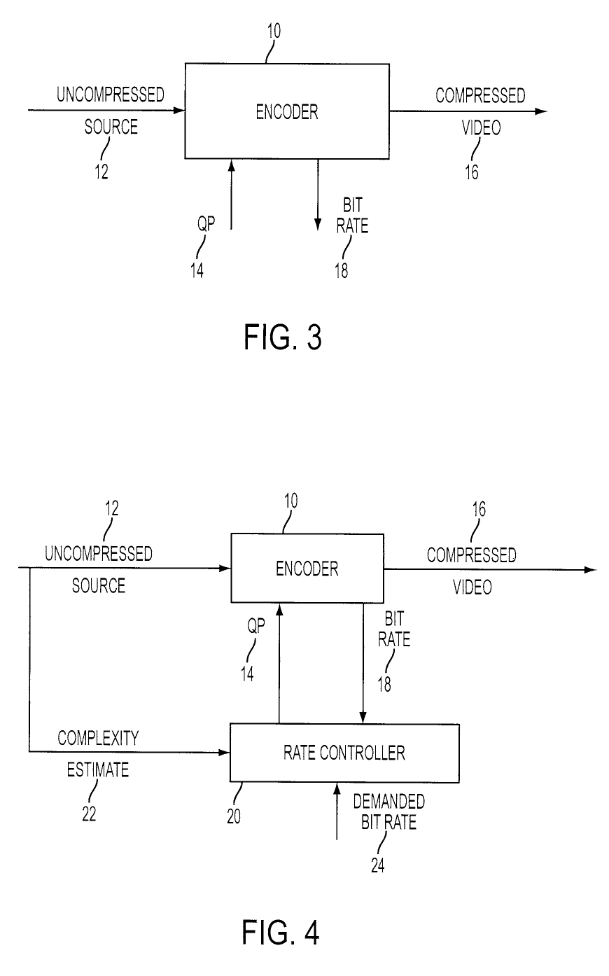

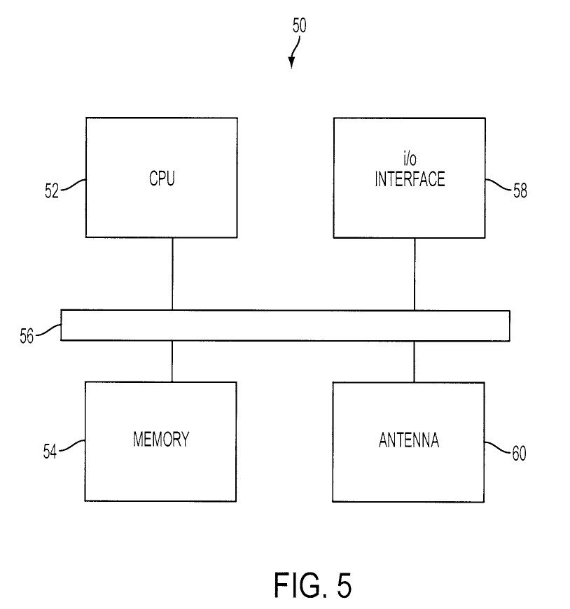

As shown in FIG. 5, according to an exemplary embodiment, a communication device 50 that is capable of compressing video includes a processor 52 for executing various functions and commands related to video compressor. The processor 52 may include the encoder 10 and the rate controller 20 shown in FIGS. 3 and 4, or may be connected thereto. The processor 52 is connected to a memory 54 via a bus 56. In addition, the communication device may include an input/output (I/O) interface 58 via which a user may enter commands, such as voice commands, written instructions, etc. The I/O interface 58 may include a keyboard, a mouse, a free space device, a microphone, a camera, etc. The communication device 50 may also include an antenna 60 via which information is exchanged wireless with another communication device. The communication device 50 may include other peripherals that are common for a computer or mobile phone.

The novel process for video compressing that will be discussed in the following embodiments may be implemented in the communication device 50. The processor 52 may be configured to act as an encoder/decoder and also as a control unit or the communication device 50 may be fitted with dedicated circuitry for encoding/decoding and controlling the video. According to an exemplary embodiment, the process partitions frames (a frame is one of the many still images which compose a complete moving picture), which are received at the communication device, into groups of blocks (GOB) and uses statistics of the groups of blocks to choose a quantization level that produces an even bit rate and a smooth quantization distribution within the frames. For example, one possible partition is dividing the frames into rows of macroblocks. A row of macroblocks may be defined as those blocks that share a common characteristic, for example a same QP or, more generally, a substantially similar QP (inclusive of a same QP). Throughout this disclosure, the GOBs are referred to as rows of macroblocks or simply rows. However, as described later, the processes discussed in the disclosure also work when the GOB is chosen as parts of, or a number of, macroblock rows.

According to an exemplary embodiment, the GOB is chosen to be a macroblock row and the video codec used is H.264. A codec is a device or program capable of encoding and/or decoding a digital data stream or signal. Thus, a frame is made up of a plurality of rows and in this embodiment the row is the GOB. Each GOB is characterized by energy and QP. The QP may be determined based on statistics from the same row in a previous frame or frames and from the previously encoded rows in the same frame. The energy, the QP and the size in bits of the encoded row may be linked by formula (1), which is characteristic for H.264 (for another codec formula (1) may be modified):

Qᵢ=−A·ln(Bitsᵢ)+Cᵢ (1)

In formula (1) “A” is a constant, and a value of “A” which was found from experiments to produce good results regardless of the encoding size, quality and content of the video may be A=4. “Q” describes the quantization parameter QP, “C” describes the energy associated with the respective row, “Bits” describes the number of bits necessary to compress the respective row, and “i” represents the respective row and varies from 1 to the number of rows in the frame. The formula for determining the size of a row (i.e., the number of bits necessary to compress the row) when knowing the QP is then:

$${Bits}_{i} = {e}^{\frac{{Q}_{i} - {C}_{i}}{- A}} \qquad ( 2 )$$

The variable C may vary from row to row within a frame and from frame to frame within a sequence. If C is large, the number of bits for a certain QP is high, and if C is small, the number of bits for that QP is low. For this reason, C can be referred to as a measurement of the energy for that row. When a row has been encoded, both the QP and the number of bits Bits is known and from that the energy for the row may be calculated using another rewriting of formula (1):

Cᵢ=Qᵢ+A·ln(Bitsᵢ) (3)

For a sequence of frames that does not include scene cuts or flashes, i.e., sudden changes in the image from a frame to the next frame, there is a high correlation between the energy of one row in a given frame and the same row in previous frames. In addition, if the energy has increased or decreased for one row of a current frame compared to a corresponding row of the previous frame, it is likely that the next row (the row below) in the current frame has changed in a similar way. Thus, according to an exemplary embodiment, the energy of a current row in a current frame, also referred to herein as the “current row energy”, may be estimated by formula (4):

$${C}_{i} ( j ) = \frac{{aC}_{i} ( j - 1 ) + b ( \frac{{C}_{i} ( j - 1 ) \cdot {C}_{i - 1} ( j )}{{C}_{i - 1} ( j - 1 )} )}{2} \qquad ( 4 )$$

in which “i” is the current row number and “j” is the current frame number. Optional weighting constants a and b may be included in the formula to indicate that the terms may be given equal or unequal weights. Formula (4) shows that the energy of the current row in the current frame is calculated as the mean of the energy of the row corresponding to the current row in the previous frame (also referred to herein as the “corresponding row energy”), and the energy of the previous row in the current frame (also referred to herein as the “previous row energy”) multiplied by the change in energy in the previous row of the current frame and the previous row in the previous frame. Cᵢ₋₁(j−1) is also referred to herein as “a block energy” of the previous group of blocks in the previous frame. More generally, the energy of a given row in a current frame may be estimated based on the energy of a previous row in the same frame and on the energy of the same row in a previous frame and/or a previous row in a previous frame.

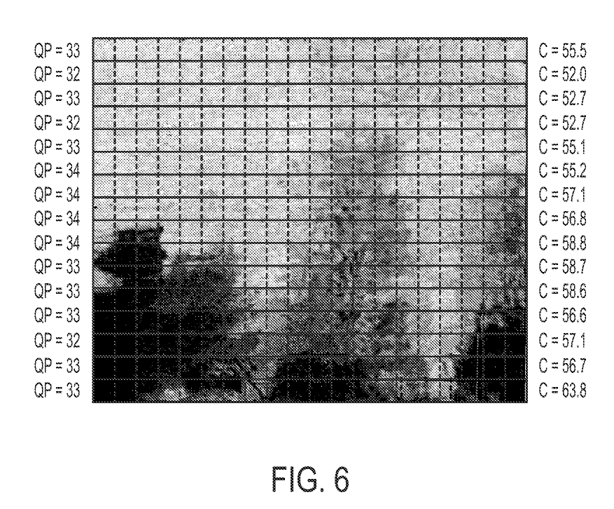

Thus, when a row is to be encoded, the desired number of bits to be used for encoding is known (as will be discussed later) and the energy estimated from formula (4) may be substituted into formula (1) to obtain the QP to be used in the encoding. In this respect, FIG. 6 shows an exemplary image for which the QP and energy levels used for encoding are shown. The energy is lower in the “easy” to code areas on the top half of the frame and higher in “harder” to code bottom half of the frame.

Calculating the QP for a row based on the bit rate of the row and the energy of the row is one aspect of the process for encoding/compressing the image. Various other aspects are involved in this process, which are discussed next. One or more of these aspects may be implemented in the communication device together with the calculation of the QP for the rows. After a discussion of some of these aspects, an exemplary process, which includes these aspects, is discussed for a better understanding of the disclosure.

The calculation of target bits for a frame is one of the aspects mentioned above. The process assumes that the target number of bits is known for each frame. The target number of bits for a frame may be decided by using an averaging buffer. The desired bit rate and frame rate is specified and given as input, before the encoding starts. These rates may be used to calculate the target size for each frame. For example, if an averaging buffer is used, the target size for a frame may be 1000 bytes and if the encoded frame has a size of 950 bytes, then the target for the next frame is set to 1050 bytes. Thus, if the encoder achieves the target on the second frame, the bit rate is evened out to 1000 bytes/frame on average per frame.

Another aspect of the encoding process is related to the calculation of the target bit for a row of a frame. When a frame has been encoded, the number of bits used for the different rows may vary. There are two factors that affect how many bits are used for encoding a row, the energy of the row and the QP used for the row. However, when determining the bit target for a row, it is desirable to take into account the variation in energy of the row but not the variation of the QP of the row. This is so because it is desirable to use the statistics from the previous frame. Ideally, the same QP is used for all the rows in a frame. However, because of the uncertainty in QP during encoding of the previous frame, it will typically have been encoded with different QPs for different rows. Thus, the encoding of the current frame may not use the true number of bits from the encoding of the previous frame when the targets for the current frame are set up, but rather the encoding should estimate how many bits each row would have cost if the bits were encoded with the same QP and use this bit number because it is desirable to use the same QP for all rows.

When a frame has been encoded, the energy is known for each row, and the average QP may be calculated. The energy may be inserted into formula (1) together with the average QP to determine an estimation of how the bits would have been distributed if all rows were encoded with the same QP. This distribution of the bits is used when calculating the target bits for each row in the next frame. It is noted that the calculated distribution of the bits to be used in the frame to be encoded is different from the distribution of the bits in the already encoded, previous, frame. In addition, the target bit for a row is calculated with respect to the bits left when the row above the current row has been encoded, in order to match the bit target of the frame. This process is not applied if there is low correlation between a previous frame and the current frame, as will be discussed later.

Another aspect of the encoding process is related to the recoding of a row. In some cases, the QP that is calculated from formula (1) gives rise to a coding with too few or too many bits with respect to the target bit of the row, when comparing the target bits to a given threshold. If this situation occurs, the row may be recoded with a QP calculated from the energy that is retrieved in the first encoding to reduce or increase the number of bits relative to the given threshold. For the last row, the threshold is set to achieve the target bit of the entire frame, i.e., the difference between encoded bits and target bits is no more than a specified limit for the frame. According to an exemplary embodiment, each row has its own threshold set with respect to a target of the row and the last row has a threshold set with respect to the frame.

In another aspect related to the coding process, the QP may be changed within a row, i.e., a first QP is used for a first part of the row and a second QP, different from the first QP, is used for a second part of the same row. According to this exemplary embodiment, this (rare) case occurs when one QP for the last row gives too many bits for the whole frame (above a specified threshold) but the next QP value gives too few bits for the whole frame (below a specified threshold). In this particular case, the QP changes within the last row. A process that produces the right amount of bits (if the distance between the thresholds interval is large enough) is to start with the lower QP and after each macroblock, evaluate if the total number of bits is above the lower threshold. When this threshold is passed, the QP is increased by one.

In still another aspect related to the encoding process, the QP is temporally aligned. More specifically, when the QP is calculated with formula (1) for a current row in a current frame, the effective QP of a corresponding row in the previous frame is not taken into account, although it is easier to encode a row if that row had a low QP in the previous frame and harder to encode the row if that row had a high QP in the previous frame. To take into account the QP of the corresponding row in the previous frame, the current QP is approximated by:

$${Q}_{approximation} = \frac{{Q}_{temporal} + {Q}_{calculated}}{2} \qquad ( 5 )$$

where ^{Q}^{ₜₑₘₚₒᵣₐₗ} is the QP for the same row in the previous frame and ^{Q}^{_{calculated}} is the QP of the current row in the current frame calculated from formula (1). This temporal QP alignment may not be performed at all times.

In another aspect related to the encoding process, the QP fluctuation is moderated. The rate control discussion until now was silent about controlling the QP to not fluctuate within a picture. When the QP fluctuates within a picture, different parts of the picture may have different visual qualities. Thus, according to an exemplary embodiment, every second row is assigned a high QP and every other row is assigned a low QP. In order to obtain smoother QP transitions, a limitation for the first QP guess (not the recodings) is introduced, with respect to the row above. Having alternating low and high QPs from one row to the next row is undesirable. That is, if one row is encoded with too many bits (but still below the threshold) the next may be given much higher QP (because the bit budget is reduced), but may be encoded with fewer bits than the target. Then the QP is increased and the alternating problem occurs. The above discussed exemplary embodiment solves this problem by introducing those restrictions.

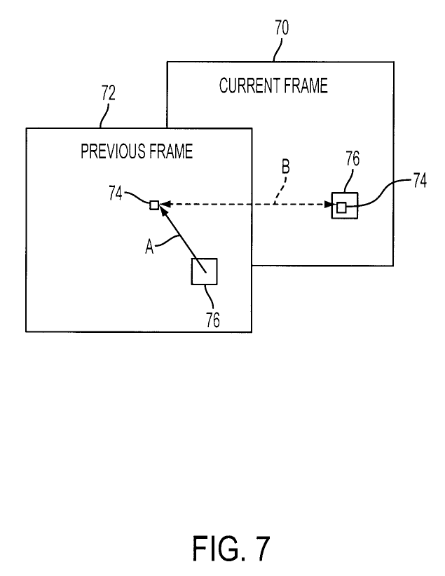

In another aspect related to the encoding process, an Extracted Sum of Absolute Differences (ESAD) novel method is used to determine differences between two frames. In natural video sequences (i.e., where the action flows without sudden changes in the frames), there is often a high correlation between two consecutive frames. This correlation is used by the modern video codecs and also when estimating the energy for a row. If there were no differences between two consecutive frames, the video sequence would just be a static image. In general, the stronger the differences between successive frames (motion changes, new objects, luminance changes etc.), the harder it is to encode (higher QP is required for a certain bit-rate) the respective frames. ESAD uses the motion vectors from the previously encoded frame together with the current frame that is going to be encoded. The Sum of Absolute Differences (SAD) is calculated for all pixels in a row with the motion vector of the latest encoded frame applied to the pixel positions, as indicated by FIG. 7. More specifically, FIG. 7 shows a current frame 70, a previous frame 72, and corresponding pixels 74 that are compared using the SAD method. A reference row 76 having the same position in both frames 70 and 72 is used to calculate the sum of absolute differences between the pixels of feature 74 in both frames. Thus, for every pixel in the frame that shall be encoded, one pixel in the reconstructed frame is used, as these two pixels are identified by arrow B. Because the motion vector A that describes the pixel 74 is extracted based on a previous frame (not shown), a low ESAD value is retrieved if the motion is constant or the frame contains areas with uniform luminance, and a high ESAD value is retrieved if there are large changes in the motions (or lightning changes, or new objects) or smaller changes in the motion of complex objects. Because ESAD is a measurement of the differences between two frames, it can be used to estimate QPs for the rows.

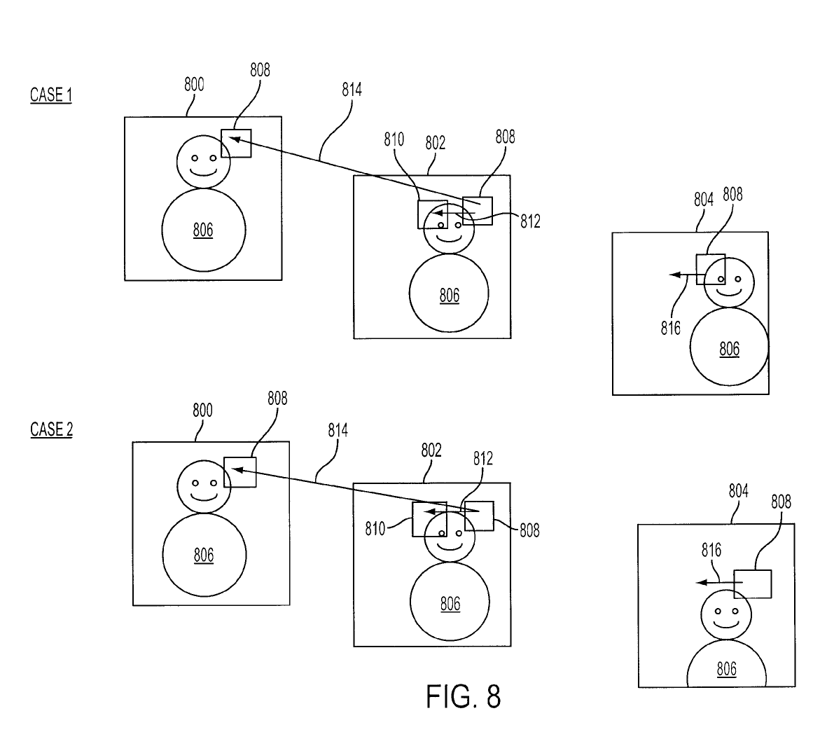

In this regard, FIG. 8 shows, for a better understanding of the ESAD method, two cases 1 and 2 producing low and high ESAD values, respectively. Case 1 of FIG. 8 shows three frames 800, 802, and 804. Frames 800 and 802 have been encoded while frame 804 has to be encoded. A moving character 806 is shown in each frame 800, 802, and 804. A row 808 is selected in frame 800 and a portion of character 806 is included in row 808. The character 806 has moved to the right in frame 802 and a row 808, corresponding to row 808 of frame 800, is shown at the same position in frame 802 as in frame 800. However, the portion of character 806 that was shown initially in row 808 of frame 800 is not in row 808 of frame 802, as the character 806 has been moved. Motion vector 812 describes the position of the portion of character 816 relative to row 808 of frame 802 and corresponds to the amount of movement of the character 806 from frame 800 to frame 802. This vector is encoded for indicating the position of the character 806 in frame 802. Vector 814 links the rows 808 of frames 800 and 802. The sum of absolute differences is calculated for each pixel in rows 808 of frames 800 and 802.

Assume that the character 808 has further moved from frame 802 to frame 804 along a straight line, for simplicity. Thus, if the motion vector encoded for frame 802 is extracted and applied to frame 804 and the sum of absolute differences is calculated for the pixels of rows 808 of frames 802 and 804, which have the same position, the ESAD value is determined. In this case, the ESAD value is low, correctly indicating a high correlation between frames 802 and 804.

With regard to Case 2, the difference from Case 1 is that character 806 moves differently from frame 802 to frame 804 than from frame 800 to frame 802. Thus, the motion vector 812 extracted from the encoding of frame 802 does not describe well the movement of the character 806 in frame 804, which results in a large ESAD value, correctly indicating the low correlation of frames 802 and 804.

However, a high ESAD value does not necessarily mean that the corresponding QP shall be increased from the previous frame, because it is possible that the previous frame also had high ESAD value. It is the difference between the ESAD value from the current frame and the ESAD value from the previous frame that reveals if the QP should be increased. Thus, based on the calculated ESAD value of the current frame relative to the previous frame, it can be detected if drastic changes are occurring in the sequence of frames.

In another aspect related to the encoding process, a scene change may be detected by using ESAD method described above. If a sequence of frames that is to be encoded contains scene cuts or abrupt scene changes (such as flashes or high speed motions), it may be necessary to make sharp increases in the QP. In these cases, there is a low correlation between the frame or frames just before the scene change and the frame or frames after the scene change. To determine whether there is or not a scene change between two or more frames, at least one of the following two conditions should take place: (1) the increase in the ESAD value for the two adjacent frames may be above a certain threshold, and (2) the ESAD value itself may be above a certain threshold. In an exemplary embodiment, both values should be above the corresponding thresholds. Once a scene change is identified, the encoding parameters for a frame that is the first in the scene are set in the same way as they are set when a first frame in a sequence is encoded. Thus, the estimated QP for the frame in the scene change is calculated, according to an exemplary embodiment, only from the target bits for the frame and the frame size. Therefore, the ESAD values are desirable to be calculated prior to encoding in order to decide a suitable encoding method.

In another aspect related to the encoding process, an energy change detection and compensation in the rows of a frame is performed using the ESAD method. As described above, an increase in energy may be detected by analyzing the difference of the ESAD values for two different but adjacent frames. If the ESAD value has increased (significantly) in some rows but not in all rows of one frame but no scene change is detected, two operations may be performed. First, the bit distribution, which is used in the encoding, is increased for those rows that have an ESAD increase to accommodate the increase in energy. Second, the Qtemporal introduced in equation (5) may be increased for all the rows in the frame, to ensure that the quality level is smooth for the whole frame even when QP has to be increased. The magnitudes of the increments are determined based on the magnitude of the ESAD increments. In one exemplary embodiment, the magnitude of the increments is proportional to the magnitude of the ESAD increments and they have a maximum value.

The novel rate control and associated aspects discussed above have been implemented in an H.264 encoder. However, the process is not limited to H.264 but may be used with any codec that uses quantization levels. For those cases, the Bits, QP, and Energy formulas 1, 2 and 3, are adjusted depending on the nature of the quantization for that codec (for example logarithmic or linear).

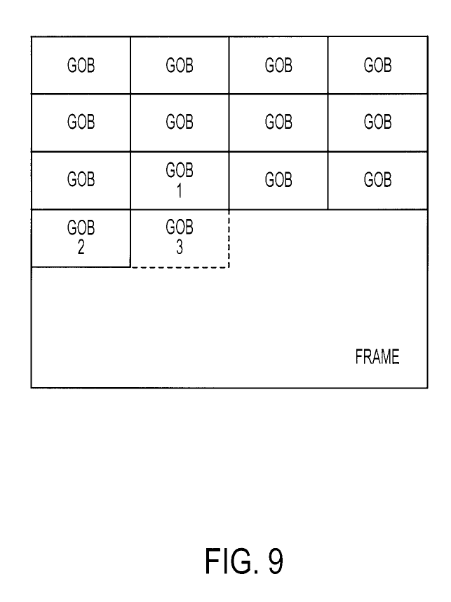

In an exemplary embodiment, the frames may be partitioned in other ways than macroblock rows. The GOBs may consist of a number of rows or part of a row. In this respect, FIG. 9 shows an example in which the rows are split in four. Both the GOB 1 above and the GOB 2 to the left of the current GOB 3 may be used to predict energy changes in the current GOB 3.

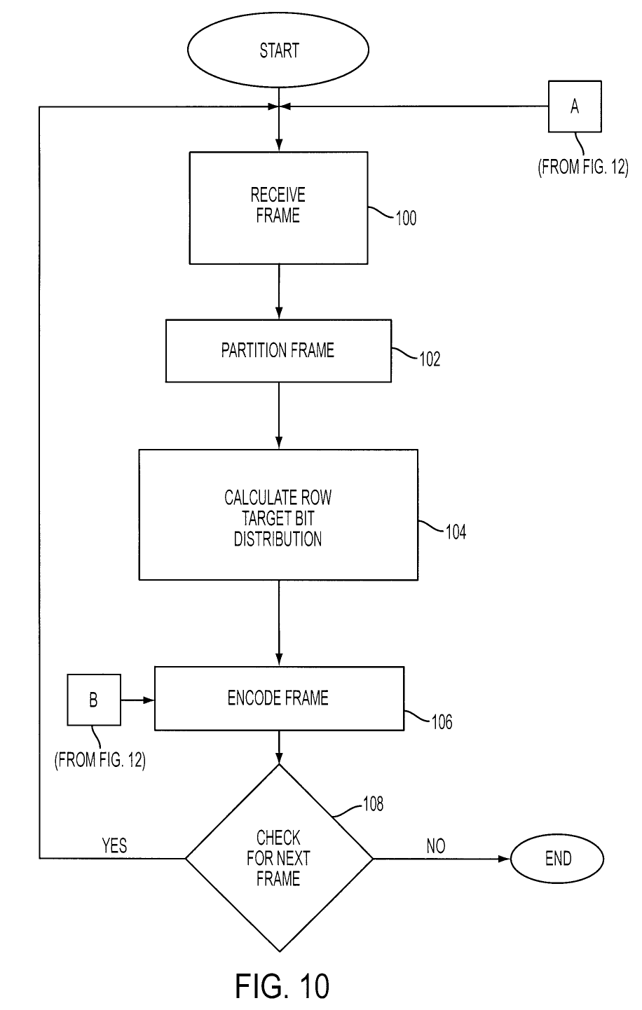

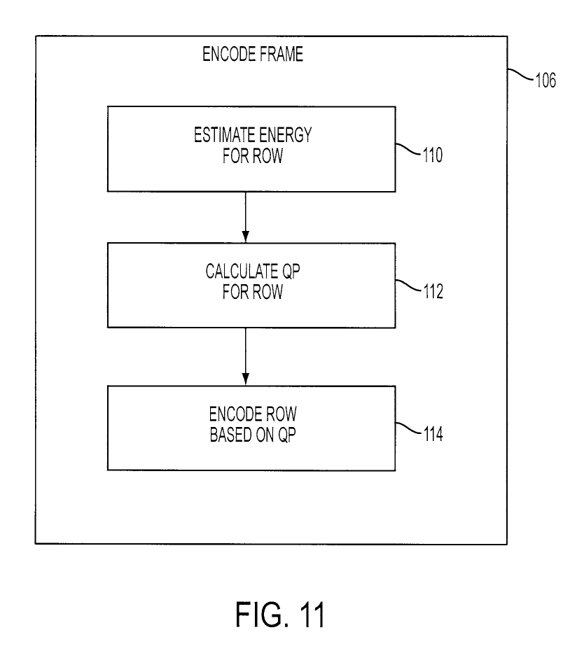

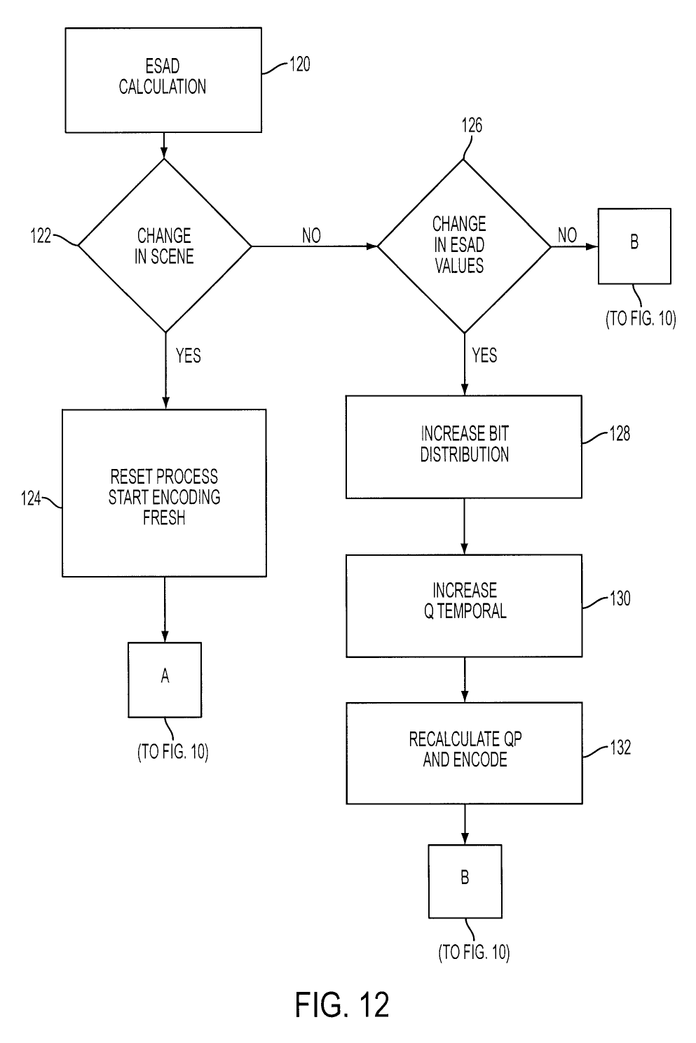

An exemplary encoding process is discussed with reference to FIG. 10. This exemplary encoding process is not meant to limit the invention or to suggest that the invention should be implemented following this exemplary encoding process. The purpose of the following exemplary encoding process is to facilitate the understanding of an embodiment and to provide the reader with one of many possible implementations of the processes discussed above. FIG. 10 shows a flow chart illustrating various steps performed during the encoding process. The steps shown in FIG. 10 are not intended to completely describe the encoding process but only to illustrate some of the aspects discussed above.

The encoding process starts in step 100 with receiving one or more frames that have to be encoded. In step 102 the current frame is partitioned into groups of blocks, for example, groups of rows. In step 104, the encoding device calculates the row target bit distribution. In step 106, the frame is encoded. In step 108, the communication device verifies whether new frames have to be encoded. If more frames have to be encoded, the process returns to step 100. If no frames are left to be encoded, the encoded frames are transmitted to another communication device and the process ends.

Step 106 of encoding the frame includes various substeps which are shown in FIG. 11. In step 110, the energy for a row is estimated, in step 112 the QP is calculated for that row, and in step 114 the row is encoded based on the calculated QP.

Various optional features may be added to the process described in FIG. 10. More specifically, with regard to FIG. 12, an ESAD calculation step 120 may be implemented at step 106 shown in FIG. 10. The ESAD calculation step 120 determines whether a scene changes from one previous frame to a current frame in step 122. If the change in scene is determined in step 122, the process advances to step 124, in which the encoding is reset, i.e., the knowledge about previous frames is not used and the current frame is encoded as it is a first frame, and the flow returns to block 100 as indicated by points A in FIGS. 10 and 12. However, if no change in scene is determined in step 122, then the process advances to step 126, in which a change in ESAD values is determined. If no change in ESAD values is determined, the process returns to point B in FIG. 10 and the frame is encoded. If a change in ESAD values is determined in step 126, then a distribution of row bits allocated for encoding the group of rows is increased in step 128. The process advances to step 130, in which the Qtemporal may be increased and to step 132, in which a new QP is calculated that is different from QP calculated in step 112, and the encoding is performed with this new value, as indicated by the point B. The steps discussed with regard to FIG. 12 are optional. The process returns then to step 108.

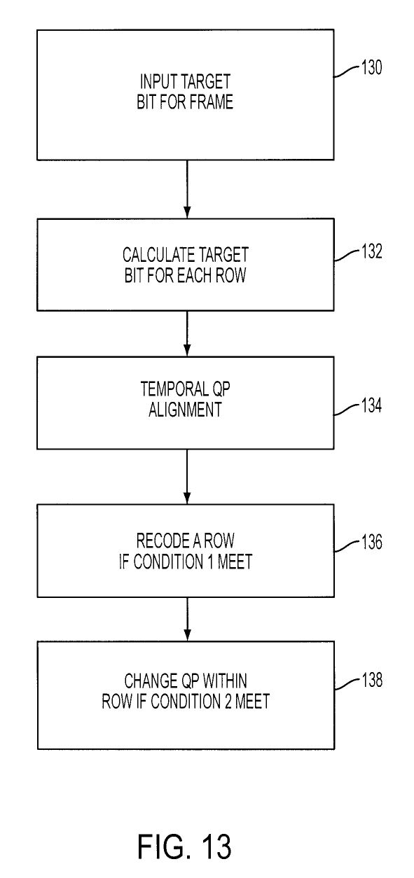

FIG. 13 is another flow chart that shows optional steps that may be performed while calculating the QP in step 112 in FIG. 11. More specifically, in step 130 a target bit for a frame is provided, for example, by a user, in step 132 a target bit for each row or group of rows is calculated, in step 134 the calculated QP is corrected with a temporal QP value, in step 136 a row is recoded if a first condition 1 is meet (as already explained above), and in step 138 the QP is changed within the row in order to achieve the desired target of bits for the frame if a condition 2 is met (as also discussed above) The order of the steps shown in FIG. 13 may be different than the one illustrated in the figure.

The rate control process disclosed in the exemplary embodiments has a low complexity overhead and is efficient at achieving a target within a specified interval. The process is also flexible as it works for many frame sizes, bit rates, frame rates and the process may be applied to all video codecs that use quantization levels.

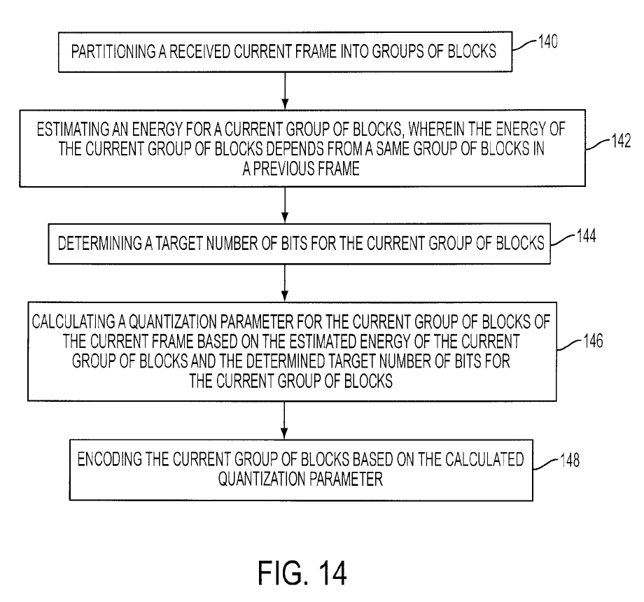

According to an exemplary embodiment, a method for controlling a bit rate when encoding video data is illustrated in FIG. 14. According to this method, the video data includes a plurality of frames and in step 140, a received current frame is partitioned into groups of blocks, in step 142 an energy for a current group of blocks is estimated, where the energy of the current group of blocks depends from a same group of blocks in a previous frame, in step 144 a target number of bits for the current group of blocks is determined, in step 146 a quantization parameter is calculated for the current group of blocks of the current frame based on the estimated energy of the current group of blocks and the determined target number of bits for the current group of blocks, and in step 148 the current group of blocks is encoded based on the calculated quantization parameter.

The disclosed exemplary embodiments provide a communication system, a method and a computer program product for encoding video data. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

As also will be appreciated by one skilled in the art, the exemplary embodiments may be embodied in a wireless communication device, a telecommunication network, as a method or in a computer program product. Accordingly, although the exemplary embodiments described above refer to the usage of an encoder 10 and a CPU 52 which can be used to perform, for example, the various encoding and partitioning, estimating, determining and calculating functions, respectively, it will be appreciated that other “means” for performing the afore-described functions may likewise be used in other exemplary embodiments. For example, in such exemplary embodiments the “means” for performing such functions may take the form of pure hardware, pure software or both hardware and software components. Thus, the exemplary embodiments or “means” may take the form of a computer program product stored on a computer-readable storage medium having computer-readable instructions embodied in the medium. Any suitable computer readable medium or “means” may be utilized including hard disks, CD-ROMs, digital versatile disc (DVD), optical storage devices, or magnetic storage devices such a floppy disk or magnetic tape. Other non-limiting examples of computer readable media or “means” include flash-type memories or other known memories.

The present exemplary embodiments may be implemented in a user terminal, a base station, and generally in a wireless communication network or system comprising both the user terminal and the base station. Thus, the exemplary embodiments, as well as the various “means” for performing the afore-described functions may also be implemented in an application specific integrated circuit (ASIC), or a digital signal processor. Suitable processors or “means” include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. A processor in association with software may be used to implement a radio frequency transceiver for use in the user terminal, the base station or any host computer. The user terminal may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

Although the features and elements of the present exemplary embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a general purpose computer or a processor.

What is claimed is:

1. A method for controlling a bit rate when encoding video data that includes a plurality of frames, comprising:
partitioning a received current frame into groups of blocks;
estimating a current row energy for a current group of blocks, wherein the current row energy of the current group of blocks is based, at least in part, on a corresponding row energy associated with a corresponding group of blocks in a previous frame;
determining a target number of bits for the current group of blocks;
calculating a quantization parameter for the current group of blocks of the current frame based on the estimated current row energy of the current group of blocks and the determined target number of bits for the current group of blocks; and
encoding the current group of blocks based on the calculated quantization parameter.

2. The method of claim 1, wherein the estimating a current row energy further comprises:
estimating the current row energy for the current group of blocks based on a previous row energy associated with a previous group of blocks in the same frame.

3. The method of claim 1, further comprising:
receiving the plurality of frames that include the current frame.

4. The method of claim 1, wherein the partitioning further comprises:
partitioning each received frame into groups of rows that have substantially the same quantization parameter.

5. The method of claim 1, wherein the estimating a current row energy further comprises:
calculating the current row energy Cᵢ(j) of the current group of blocks “i” of the current frame “j” as
$${C}_{i} ( j ) = \frac{{aC}_{i} ( j - 1 ) + b ( \frac{{C}_{i} ( j - 1 ) \cdot {C}_{i - 1} ( j )}{{C}_{i - 1} ( j - 1 )} )}{2} ,$$
where Cᵢ(j-1) is the corresponding row energy of the corresponding group of blocks in the previous frame, Cᵢ₋₁(j) is the previous row energy of a previous group of blocks in the current frame, Cᵢ₋₁(j−1) is a block energy of the previous group of blocks in the previous frame, and a and b are weighting constants.

6. The method of claim 1, wherein the calculating a quantization parameter further comprises:
calculating the quantization parameter as a function of the estimated current row energy of the current group of blocks and the determined target number of bits for the current group of blocks.

7. The method of claim 1, wherein the determining further comprises:
calculating the target number of bits for a group of rows based on the target number of bits for the frame.

8. The method of claim 1, further comprising:
recoding the current group of blocks when the encoding produces a number of bits lower than a first threshold or higher than a second threshold, wherein the first threshold is different from the second threshold.

9. The method of claim 1, further comprising:
changing the quantization parameter within the current group of blocks.

10. The method of claim 1, further comprising:
replacing the calculated quantization parameter of the current group of blocks by an approximate quantization parameter that is an average of the calculated quantization parameter and a quantization parameter for the same group of blocks in the previous frame.

11. The method of claim 1, further comprising:
calculating an extracted sum of absolute difference (ESAD) value for the current frame and a previous frame to determine a change in a scene, wherein the scene is represented by the previous frame and the current frame and wherein the ESAD value is calculated based on an extracted motion vector from the previous frame.

12. The method of claim 11, further comprising:
changing a number of bits allowed for the group of blocks when the change in the scene is not determined but a change in the ESAD value is determined.

13. The method of claim 11, further comprising:
determining the change in scene when a change of the extracted sum of absolute difference value is above a first threshold and when the extracted sum of absolute difference value is above a second threshold, wherein the first threshold is different from the second threshold.

14. A computer readable medium for storing computer executable instructions, wherein the instructions, when executed by a processor, cause the processor to control a bit rate when encoding video data that includes a plurality of frames, the instructions comprising:
partitioning a received current frame into groups of blocks;
estimating a current row energy for a current group of blocks, wherein the current row energy of the current group of blocks is based, at least in part, on a corresponding row energy associated with a corresponding group of blocks in a previous frame;
determining a target number of bits for the current group of blocks;
calculating a quantization parameter for the current group of blocks of the current frame based on the estimated current row energy of the current group of blocks and the determined target number of bits for the current group of blocks; and
encoding the current group of blocks based on the quantization parameter.

15. A communication device for controlling a bit rate when encoding video data that includes a plurality of frames, the communication device comprising:
a processor configured to partition a current frame into groups of blocks; to estimate a current row energy for a current group of blocks, wherein the current row energy of the current group of blocks is based, at least in part, on a corresponding row energy associated with a corresponding group of blocks in a previous frame; to determine a target number of bits for the current group of blocks; and to calculate a quantization parameter for the current group of blocks of the current frame based on the estimated current row energy of the current group of blocks and the determined target number of bits for the current group of blocks; and
an encoding unit associated with the processor and configured to encode the current group of blocks based on the calculated quantization parameter.

16. The communication device of claim 15, wherein the processor is further configured to:
estimate the current row energy for the current group of blocks based on a previous row energy associated with a previous group of blocks in the same frame.

17. The communication device of claim 15, further comprising:
a receiving unit configured to receive the plurality of frames that include the current frame.

18. The communication device of claim 15, wherein the processor is further configured to:
partition each received frame into groups of rows that have substantially the same quantization parameter.

19. The communication device of claim 15, wherein the processor is further configured to:
calculate the current row energy Cᵢ(j) of the current group of blocks “i” of the current frame “j” as
$${C}_{i} ( j ) = \frac{{aC}_{i} ( j - 1 ) + b ( \frac{{C}_{i} ( j - 1 ) \cdot {C}_{i - 1} ( j )}{{C}_{i - 1} ( j - 1 )} )}{2} ,$$
where Cᵢ(j−1) is the corresponding row energy of the corresponding group of blocks in the previous frame, Cᵢ₋₁(j) is the previous row energy of the previous group of blocks in the current frame, Cᵢ₋₁(j−1) is a block energy of a corresponding group of blocks of the previous group of blocks in the previous frame, and a and b are weighting constants.

20. The communication device of claim 15, wherein the processor is further configured to:
calculate the quantization parameter as a function of the estimated current row energy of the current group of blocks and the determined target number of bits for the current group of blocks.

21. The communication device of claim 15, wherein the processor is further configured to:
calculate the target number of bits for a group of rows based on the target number of bits for the frame.

22. The communication device of claim 15, wherein the encoding unit is further configured to:
recode the current group of blocks when the coding produces a number of bits lower than a first threshold or higher than a second threshold, wherein the first threshold is different from the second threshold.

23. The communication device of claim 15, wherein the processor is further configured to:
change the quantization parameter within the current group of blocks.

24. The communication device of claim 15, wherein the processor is further configured to:
replace the calculated quantization parameter of the current group of blocks by an approximate quantization parameter that is an average of the calculated quantization parameter and a quantization parameter for the same group of blocks in a previous frame.

25. The communication device of claim 15, wherein the processor is further configured to:
calculate an extracted sum of absolute difference (ESAD) value for the current frame and a previous frame to determine a change in a scene, wherein the scene is represented by the previous frame and the current frame and wherein the ESAD value is calculated based on an extracted motion vector from the previous frame.

26. The communication device of claim 25, wherein the processor is further configured to:
change a number of bits allowed for the group of blocks when no change in the scene is determined but an ESAD value change is determined.

27. The communication device of claim 25, wherein the processor is further configured to:
determine the change in scene when a change of the extracted sum of absolute difference value is above a first threshold and when the extracted sum of absolute difference value is above a second threshold, wherein the first threshold is different from the second threshold.

28. A communication device for controlling a bit rate when encoding video data that includes a plurality of frames, the communication device comprising:
means for partitioning a received current frame into groups of blocks; for estimating an energy for a current group of blocks, wherein the energy of the current group of blocks depends from a same group of blocks in a previous frame; for determining a target number of bits for the current group of blocks; and for calculating a quantization parameter for the current group of blocks of the current frame based on the estimated energy of the current group of blocks and the input target number of bits for the current group of blocks; and
means for encoding the current group of blocks based on the calculated quantization parameter.
